(19) United States
(12) Patent Application Publication
(10) Pub. No.: US 2006/0256503 A1
(43) Pub. Date: Nov. 16, 2006

(54) Capacitor

(76) Inventors: Hisato Kato, Kanagawa (JP); Haruo Kawakami, Kanagawa (JP); Keisuke Yamashiro, Kanagawa (JP)

Correspondence Address: RABIN & Berdo, PC, 1101 14TH STREET, NW, SUITE 500, WASHINGTON, DC, 20005, US

(21) Appl. No.: 10/562,419

(22) PCT Filed: Jun. 29, 2004
(86) PCT No.: PCT/JP04/09139

§ 371 Date: Jun. 2, 2006

(30) Foreign Application Priority Data
Jun. 30, 2003 (JP) 2003-186228
Apr. 20, 2004 (JP) 2004-123649

(51) Int. Cl. H01G 4/06

(52) U.S. Cl. 361/311

(57) ABSTRACT

A flexible capacitor easily produced at low temperature. The capacitor has a dielectric material layer and two electrodes sandwiching the layer. The dielectric material layer contains metal microparticles and/or an organic charge trapping material in an organic insulating material, and the metal microparticles, have an ionization potential and an electron affinity at an energy level between the ionization potential and the electron affinity of the organic insulating material. Once the metal microparticles are charged by applying a voltage, the charge is trapped in the metal microparticles, due to the metal microparticles' energy level relative to the organic insulating material. The trapped charge acts in the same manner as dielectric polarization in the dielectric material, so that extremely large dielectric constant can be obtained practically even when the organic insulating material has a small dielectric constant.

### BACKGROUND OF THE INVENTION

1. Technical Field

The present invention relates to a dielectric material and a capacitor, particularly a capacitor for use as an electronic circuit incorporated in printed boards or integrated circuits.

2. Background Art

Recently, size, thickness, and weight of electric apparatuses have been reduced, electric circuits have been miniaturized and digitalized, and therewith there have been increasing demands of improving size, performance, and reliability of electronic components. Under such circumstances, also capacitors are required to have a small size and a high capacitance.

However, surface mounted components such as capacitors still occupy large areas of printed circuit boards. This is a major obstacle in further miniaturizing the electronic apparatuses. To overcome the problem, there have been attempts to incorporate some electronic parts, such as capacitors, in circuit boards (for example, see JP-A-10-56251 and JP-A-11-68321).

As frequency is increased and voltage is lowered in integrated circuits, malfunctions caused by changes of power supply voltage due to noise is becoming a serious problem. The problem has arisen because the allowable range of the power supply voltage is reduced when the voltage is lowered. To prevent malfunctions due to high-frequency noise, generally capacitors are placed around power supplies. Capacitors for this use are called bypass capacitors or decoupling capacitors, and act to remove the high-frequency noise and to prevent instantaneous reduction of the power supply voltage by supplying energy instantaneously from the capacitor. The electrostatic capacity of the capacitor is important for the energy supply.

Though an ideal capacitor has only electrostatic capacity components that are without resistance components and inductance components, practical capacitors have series resistance components and series inductance components. The impedance of the electrostatic capacity components is reduced and that of the inductance components is increased as the frequency is increased. Therefore, with future increases in operating frequency, the inductance components of devices and the inductance components of wirings are expected to create noise. Thus, it is required that the capacitor have inductance components that are as small as possible, and a higher self-resonant frequency to reliably perform over a high frequency area. Further, to reduce the inductance components due to the wiring distance as much as possible, the nearer to a CPU is the decoupling capacitor, the better.

On the other hand, with the above-described lowering of the power supply voltage, the rated working voltage of the capacitor will be able to be smaller in the future.

To respond to the above problems of high frequency and low voltage of the integrated circuits, proposed are methods of embedding a high-performance capacitor in a printed circuit board to minimize the wiring distance between a CPU and the capacitor (see e.g., JP-A-4-211191, JP-A-10-335178 and JP-A-11-111561). Methods of forming a capacitor into a thin film and incorporating the film in a power supply IC to form a one chip device also have been proposed in response to these problems.

Further, in small-sized portable devices typified by mobile phones, printed circuit boards mainly comprise resin substrates, so that a capacitor having flexibility similar to the resin substrates, and excellent high frequency properties, is needed.

On the other hand, in most disclosed proposals, dielectric materials are such that a ceramics-based material requiring high-temperature firing is embedded in a ceramic substrate (see e.g., JP-A-8-222656 and JP-A-8-181453).

However, such dielectric materials have problems. Ceramics-based materials are prone to breaking, peeling, or becoming contaminated in an industrial production process, and thereby deteriorates likely to fail. In particular, the material is often cracked in the electrode forming process including the processes of paste application and mounting. This causes defects in the device properties.

Further, in the case of incorporating a capacitor in a resin substrate, a ceramics paste, which is converted to a dielectric material by firing, and the resin substrate cannot be heated together at a high temperature after forming the ceramics paste on the substrate. Thus, a complicated procedure of embedding an independent ceramic capacitor in the resin substrate afterward is required.

### OBJECT AND SUMMARY OF THE INVENTION

An object of the present invention is to solve the above conventional problems, thereby providing a flexible capacitor that can be easily produced at low temperature.

To achieve this object, the capacitor of the present invention comprises a layer of a dielectric material and two electrodes sandwiching the layer, t wherein the dielectric material layer contains metal microparticles and/or an organic charge-trapping material (which are referred to as metal microparticles, etc. hereinafter) in an organic insulating material, and the metal microparticles, etc. have an ionization potential and an electron affinity at an energy level between the ionization potential and the electron affinity of the organic insulating material.

In the capacitor of the invention, once the metal microparticles, etc. are charged by applying a voltage, the charge is trapped in the metal microparticles, etc. due to their energy level relative to the organic insulating material. The trapped charge acts in the same manner as dielectric polarization in the dielectric material, so that what is effectively an extremely large dielectric constant can be obtained practically, even when the organic insulating material has a small dielectric constant.

The capacitor can be produced at room temperature by a simple method such as vacuum deposition or a spin coating method, and has flexibility, characteristic of organic materials.

In the dielectric material or capacitor containing the dielectric material according to one aspect of the invention, it is preferred that the organic insulating material is selected from among 2-amino-4,5-imidazole dicyanate, quinomethane compounds, triphenylamine compounds, and pyridone compounds, and the metal microparticles are selected from among aluminum, gold, and copper particles.

In the dielectric material or capacitor containing the dielectric material according to another aspect of the invention, it is preferred that the organic insulating material is 2-amino-4,5-imidazole dicyanate, triphenylamine compounds, or α-NPD, and the organic charge trapping material is selected from the group of materials consisting of pyridone compounds, phthalocyanine compounds, and α-6T (α-sexithiophene).

Thus, according to the invention, there are provided a dielectric material and a capacitor comprising a layer of the dielectric material and two electrodes sandwiching the layer, and the dielectric material comprises the organic insulating material, and the metal microparticles and/or the organic charge trapping material in the organic insulating material. The metal microparticles have a work function at an energy level between the ionization potential and the electron affinity of the organic insulating material, or alternatively the metal microparticles or the organic charge trapping material having an ionization potential and an electron affinity at an energy level between the ionization potential and the electron affinity of the organic insulating material.

According to the invention, there is further provided a method for producing a capacitor comprising the steps of forming an electrode thin film, applying a liquid mixture containing an organic insulating material, and metal microparticles and/or an organic charge trapping material to the formed electrode thin film, followed by drying, and forming an electrode thin film on the dried film coating the electrode thin film.

Furthermore, in the invention, there is provided a method for producing a capacitor, comprising the steps of forming an electrode thin film, codepositing an organic insulating material, and metal microparticles and/or an organic charge trapping material on the formed electrode thin film, and forming an electrode thin film on the codeposited film.

Advantage of the Invention

As described in detail below, according to the present invention, there is provided a capacitor capable of exhibiting a high relative dielectric constant and a large capacity even in the case of using an organic insulating material with a low relative dielectric constant. Further, the capacitor is flexible and can be produced at low temperature, that is near room temperature, and thereby can be suitably used in various places such as printed circuit boards and integrated circuits.

### BRIEF DESCRIPTION OF THE DRAWINGS

FIG. 1 is a schematic cross-sectional view showing one embodiment of the capacitor of the present invention.

FIG. 2 is a scanning electron microscope (SEM) photograph showing the surface of the dielectric material layer of Example 1.

### DETAILED DESCRIPTION OF THE PREFERRED EMBODIMENTS

The present invention will be described in detail below with reference to the drawings.

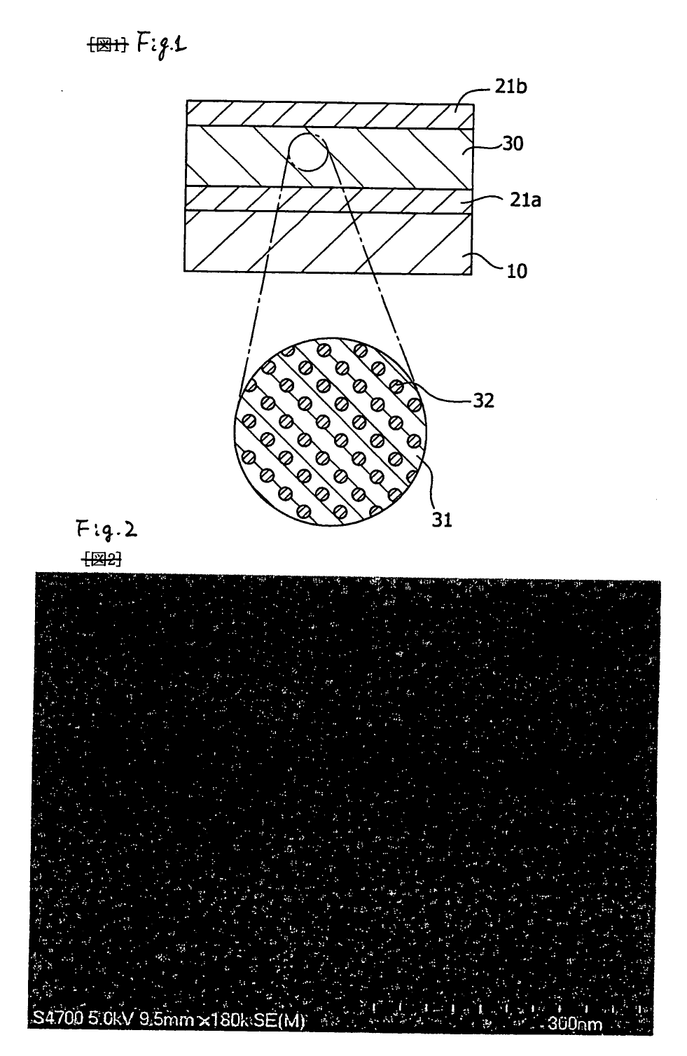

FIG. 1 is a schematic cross-sectional view showing one embodiment of the capacitor of the invention. As shown in FIG. 1, this capacitor includes an electrode layer 21a, a dielectric material layer 30 of the organic insulating material, which contains the metal microparticles, etc., and an electrode layer 21b stacked in this order on a substrate 10.

The substrate 10 is preferably a glass substrate or a film substrate of polyimide, though the substrate is not particularly restricted thereto.

The materials for the electrode layers 21a, 21b are not particularly limited and may be appropriately selected from metal materials such as aluminum, gold, silver, nickel, and iron, inorganic materials such as ITO and carbon, organic conjugated materials, organic materials such as liquid crystals, and semiconductor materials such as, for example, silicon.

In the capacitor of the invention, the dielectric material layer 30 is constituted by an ultrathin organic film. The processes for producing the capacitor are carried out at a low temperature of 100° C. or below, and the materials are flexible, so that the problems of, for example, breaking, peeling and contamination, rarely occur, unlike conventional ceramic materials.

The dielectric material layer 30 contains the metal microparticles, etc. in the organic insulating material. The work function of the metal microparticles, or the ionization potential and the electron affinity of the metal microparticles, etc. is at an energy level between the ionization potential and the electron affinity of the organic insulating material.

The work function is the minimum amount of work required to extract an electron from a solid in a vacuum.

The ionization potential is the energy required to remove one electron from a neutral atom, an ion, or a molecule. The energy for removing one outermost electron in a vacuum is defined as the first ionization potential. The energy required to remove another electron from the resultant monovalent positive ion is defined as the second ionization potential. The energy for removing the third or fourth electron is defined as the third or fourth ionization potential, respectively. Thus, a smaller ionization potential means that conversion to a positive ion occurs more easily.

In the invention, the first ionization potential is an object of consideration. The ionization potential of the dielectric material layer may be for example, measured easily by photoemission spectroscopy using a spectrophotometer (e.g. model AC-2 manufactured by Riken Keiki Co., Ltd.) in a gaseous atmosphere

The electron affinity is the energy released when one electron is added to an atom, a molecule, or a negative ion. The electron affinity is generally obtained by measuring an optical band gap from optical absorption spectra, and by adding it to the ionization potential.

The ionization potential and the electron affinity of a single atom of each metal material are obtained as a measured value or a calculated value as shown in Table 1. When a metal material has a sufficiently large size (i.e., in the bulk state), these values are observed as the work function, which can be easily measured by the above photoemission spectroscopy in the atmosphere, etc., and those of various materials have been obtained. On the contrary, it is known that when the metal material is a fine particle having nanometer (nm) size as in the invention, the values depend on the particle size. Thus, the ionization potential and the electron affinity of the material in the state of fine particles are intermediate values between the ionization potential and the electron affinity of the single atom and the work function of the bulk state. It is known that these values are fundamentally well associated with the fine particle size, though they are slightly affected by polarization in the material of the dielectric layer, and data of various metal materials have been obtained. For example, references include Clusters of Atoms and Molecules, edited by Hellmut Haberland, Spring-Verlag, Berlin, 1994.

Thus, in the most simple model, the relationships of the ionization potential IP and the electron affinity EA to the work function WF and the fine particle diameter R (nm) are represented by the following equations:
IP=WF+A/R (I)
EA=WF−B/R (II)
wherein A=3e²/8, B=5e²/8, and e is the charge of an electron.

Therefore, an estimate of the ionization potential and electron affinity can be provided by observing the fine particle size.

The organic insulating material is not particularly restricted, and may be selected, for example, from among 2-amino-4,5-imidazole dicyanate, quinomethane compounds, triphenylamine compounds, pyridone compounds, polystyrenes, polyvinyl carbazoles, α-NPD (N,N′-di(naphthalene-1-yl)-N,N′-diphenylbenzidine), TPD (N,N′-bis(3-methylphenyl)-N,N′-diphenylbenzidine), Alq3 (tris-(8-hydroxyquinolinato)aluminum), CBP (4,4′-bis(carbazole-9-yl)-biphenyl).

The average particle diameter of the metal microparticles is not particularly restricted, and is preferably 2 to 100 nm in the deposition method and 1 to 50 nm in the application method from the viewpoint of producing and dispersing the metal microparticles used.

The organic charge trapping material is required to have an ionization potential smaller than that of the organic insulating material and an electron affinity larger than that of the organic insulating material, and thereby naturally has an energy gap smaller than that of the organic insulating material. The energy gap of the organic charge trapping material, which depends on the organic insulating material to be combined therewith, is preferably 2 eV or less

More specifically, the organic charge trapping material is preferably selected, for example from among pyridone compounds, phthalocyanine compounds, thiophene compounds typified by α-6T (α-sexithiophene), acene compounds typified by pentacene.

Among the above materials, in the embodiment of using the metal microparticles, it is particularly preferred that the organic insulating material is 2-amino-4,5-imidazole dicyanate, quinomethane compounds, triphenylamine compounds, or pyridone compounds, and that the metal microparticles are constituted of at least one material selected from the group consisting of aluminum, gold, and copper.

Among the above materials, in the embodiment of using the organic charge trapping material, it is particularly preferred that the organic insulating material is 2-amino-4,5-imidazole dicyanate, triphenylamine compounds, or α-NPD, and that the organic charge trapping material is at least one material selected from the group consisting of pyridone compounds, phthalocyanine compounds, and α-6T.

The structural formula of 2-amino-4,5-imidazole dicyanate is shown below.

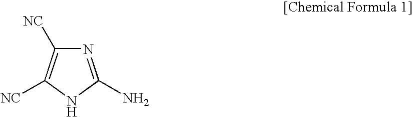

The quinomethane compounds include, but are not particularly restricted to compounds represented by the following formulae

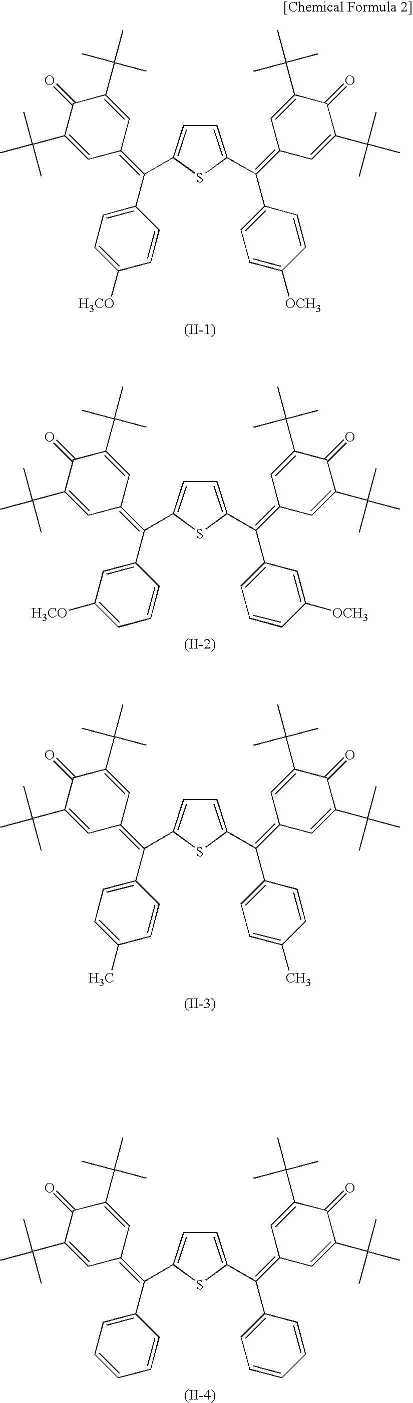

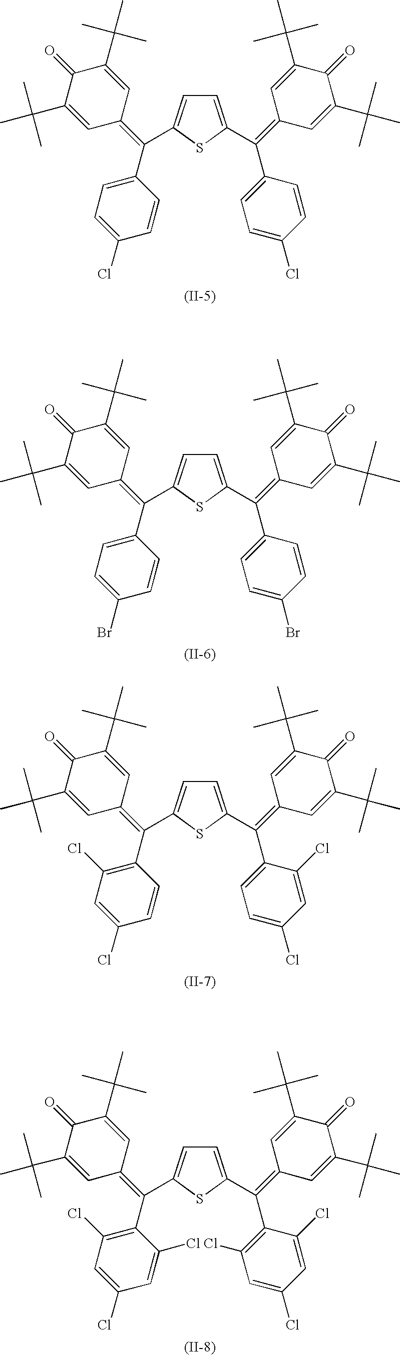

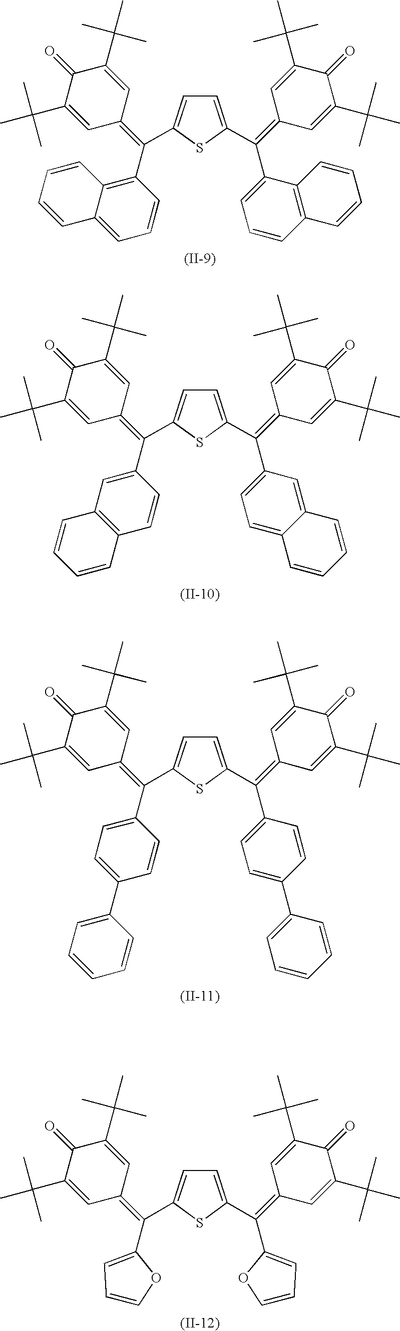

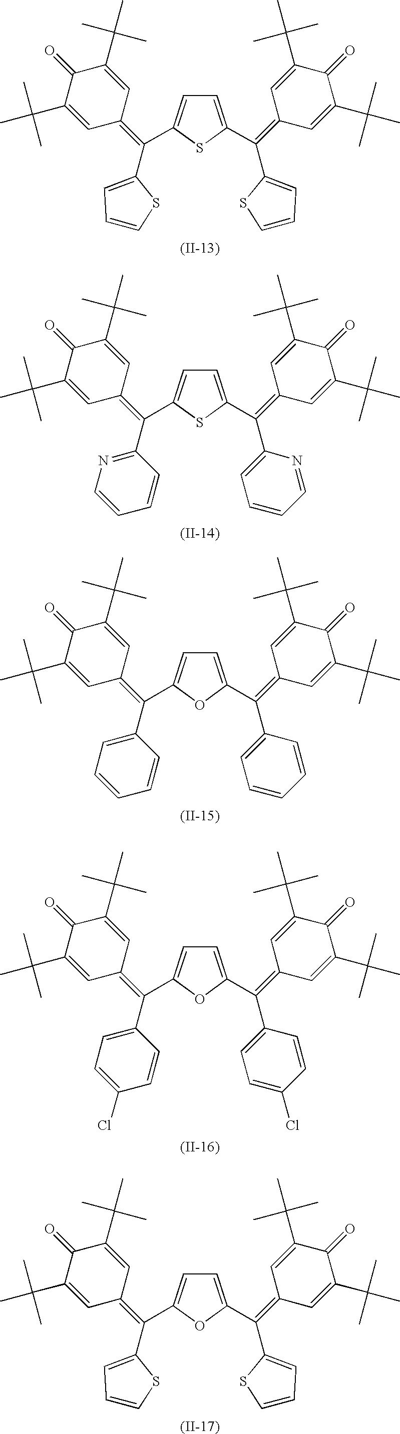

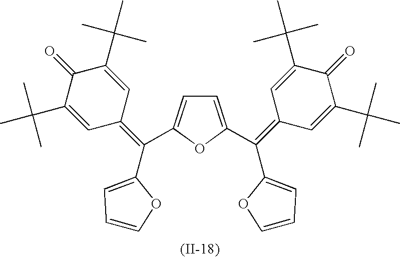

Further, the triphenylamine compounds include compounds represented by the following formulae.

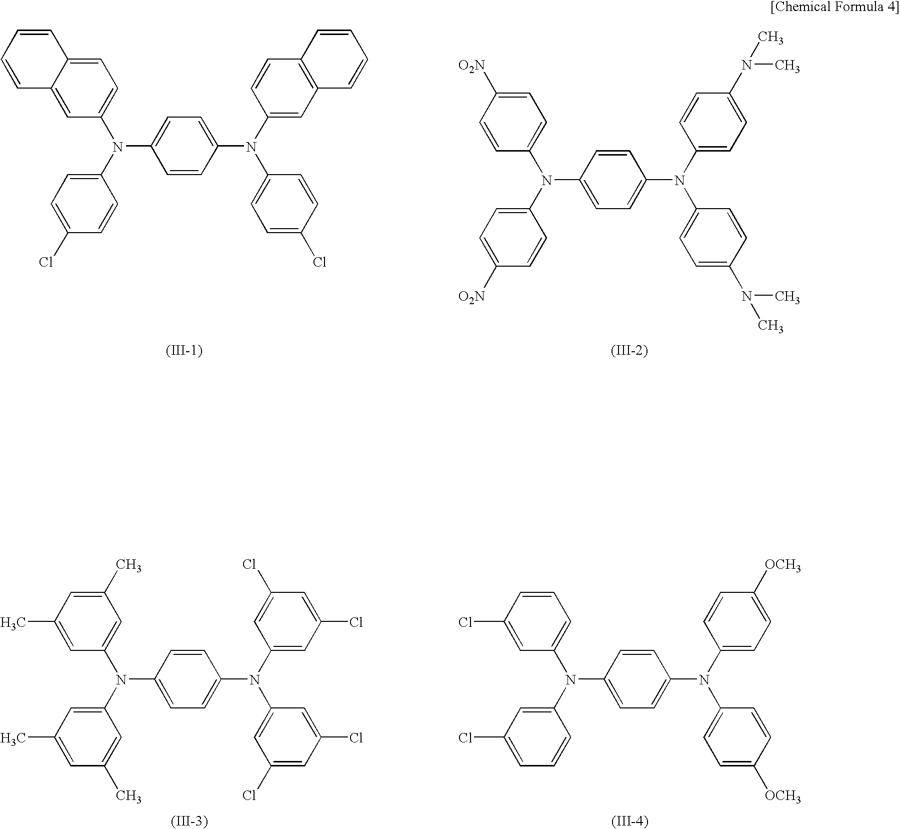

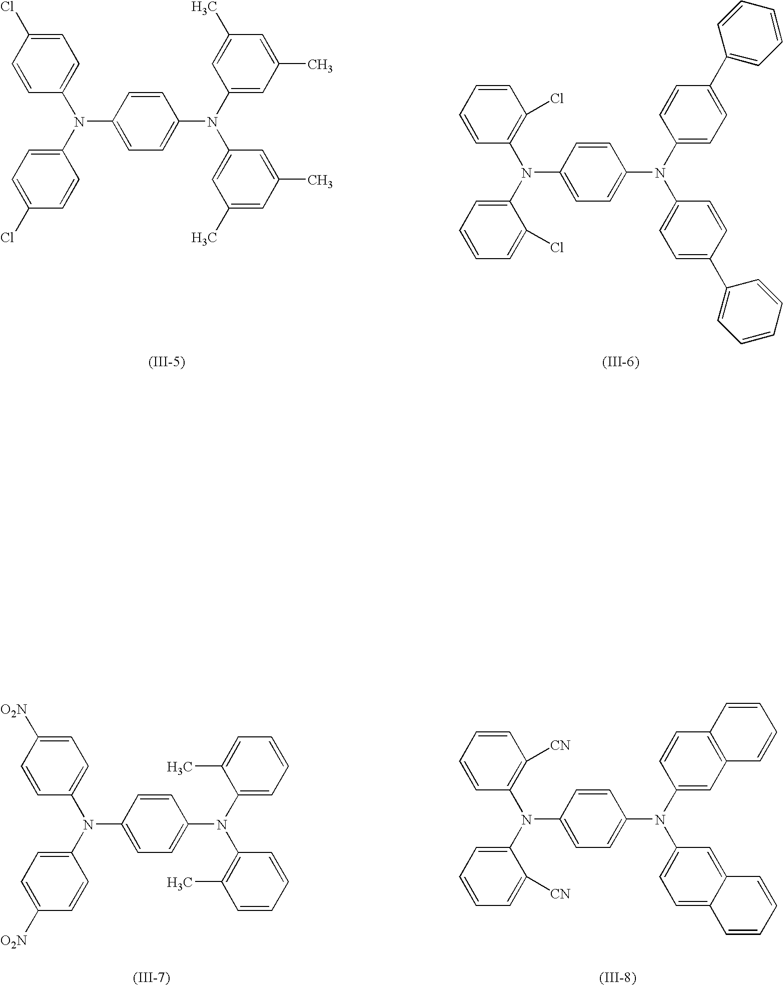

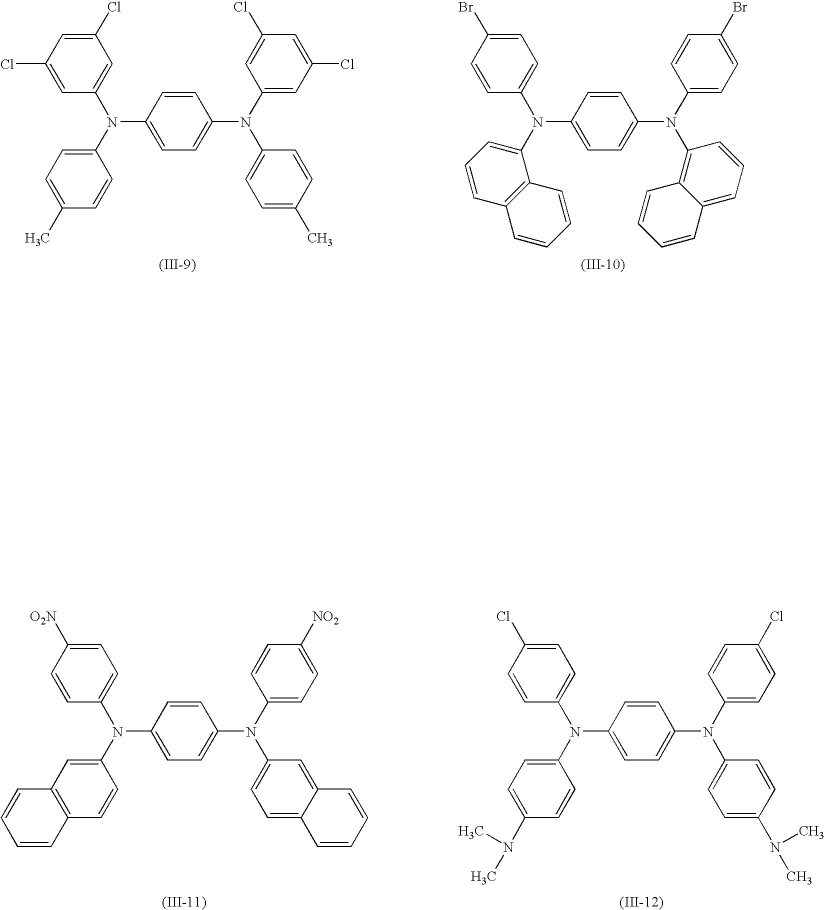

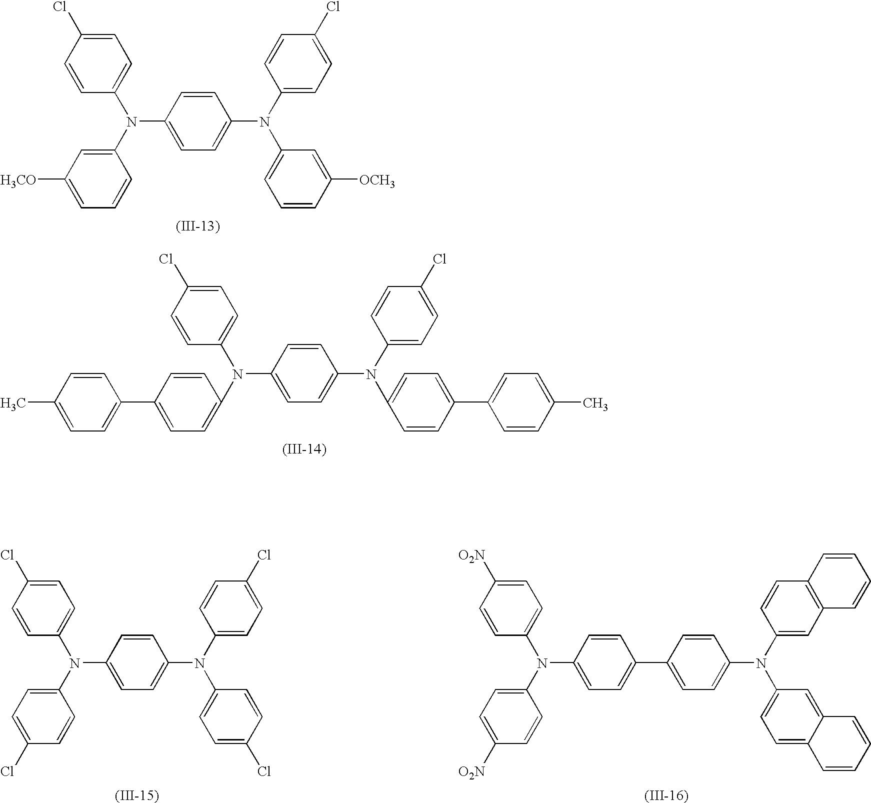

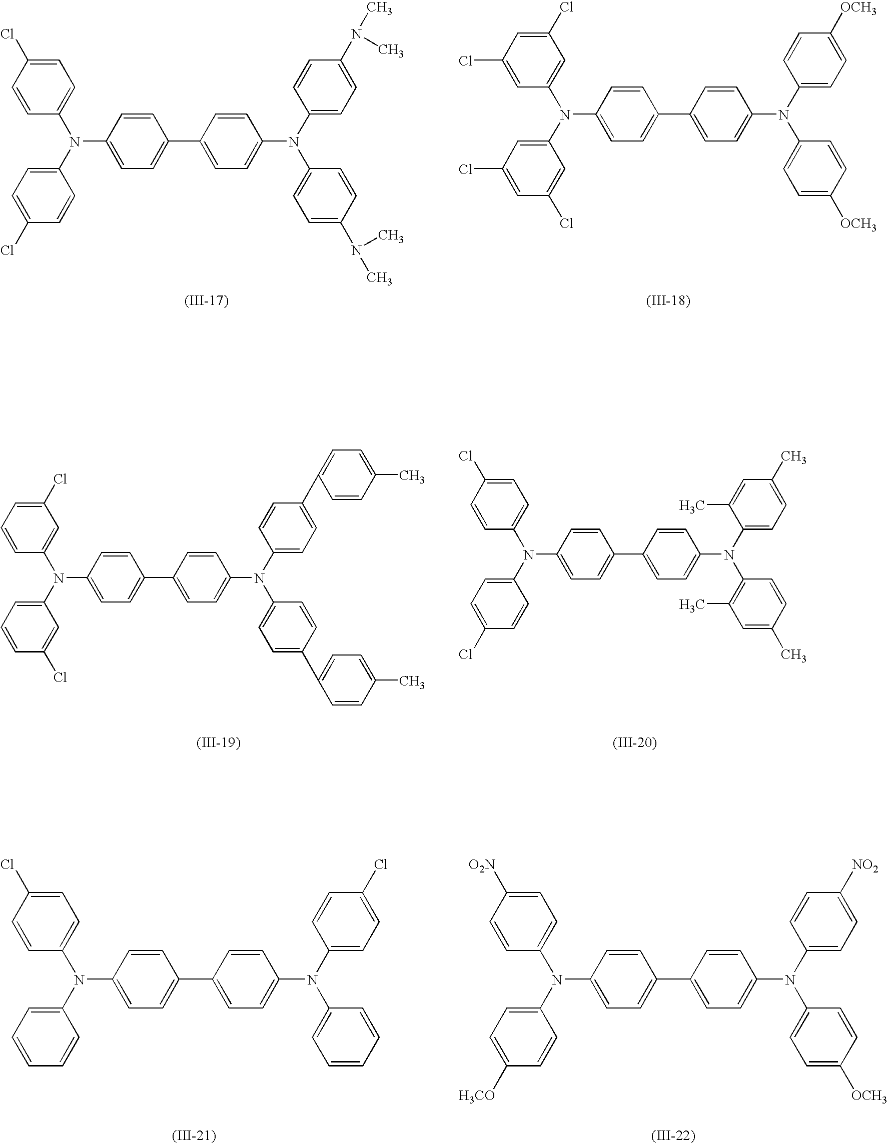

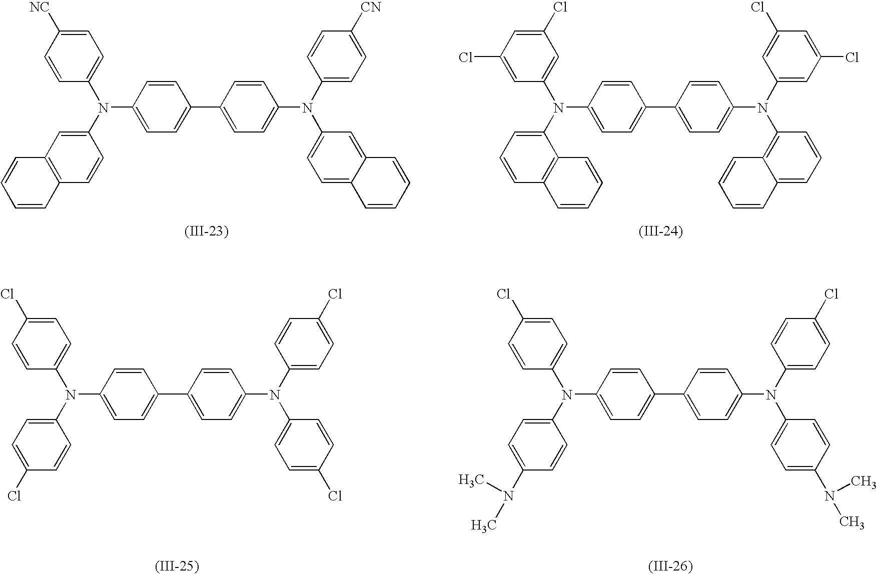

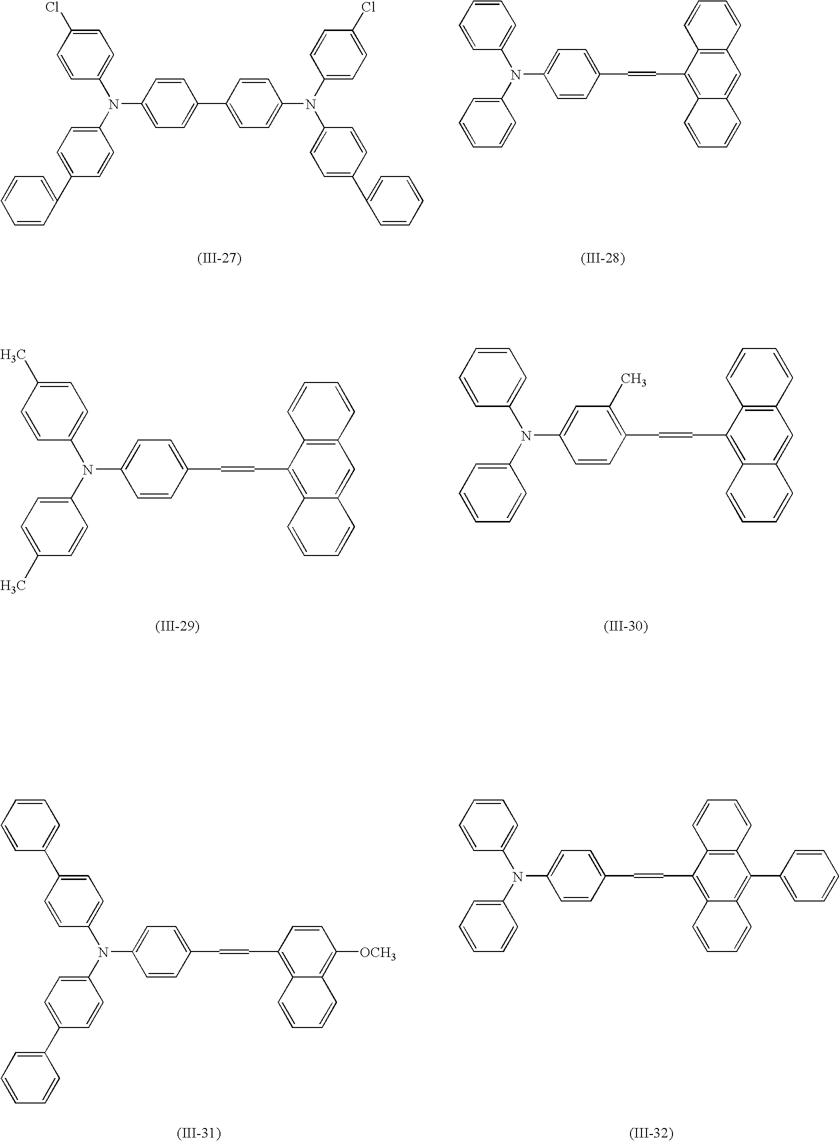

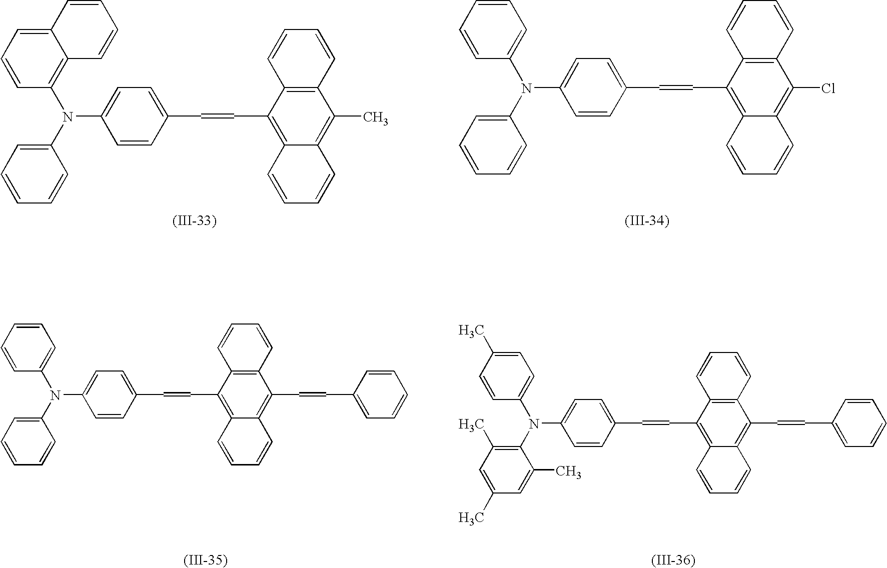

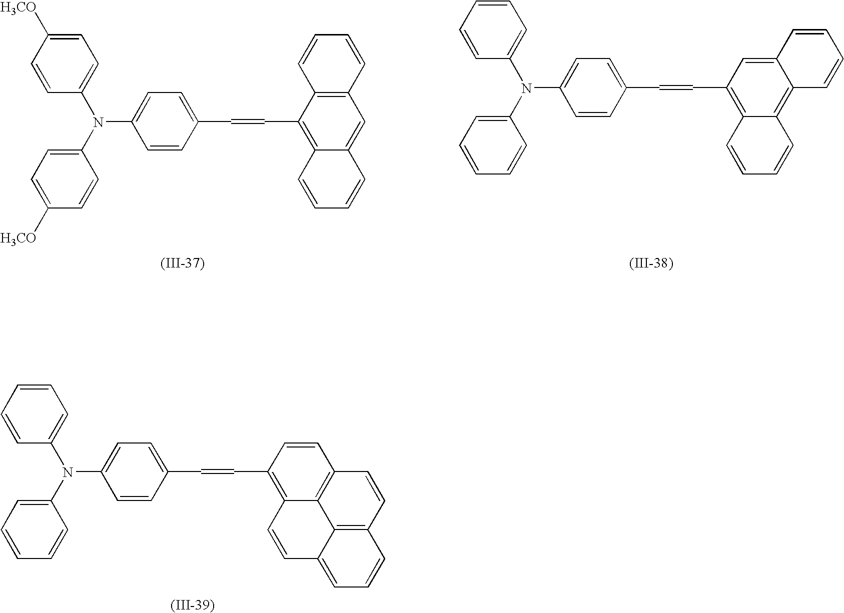

The pyridone compounds include compounds represented by the following formulae.

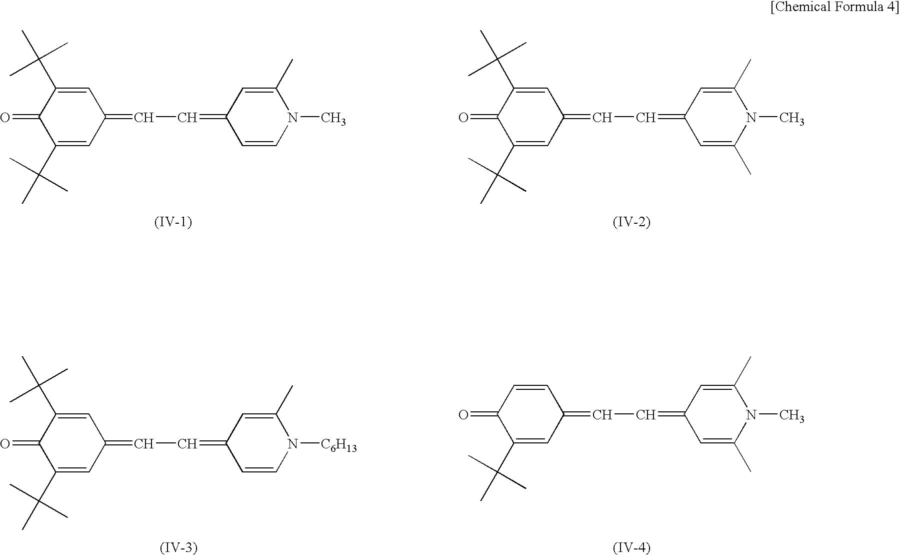

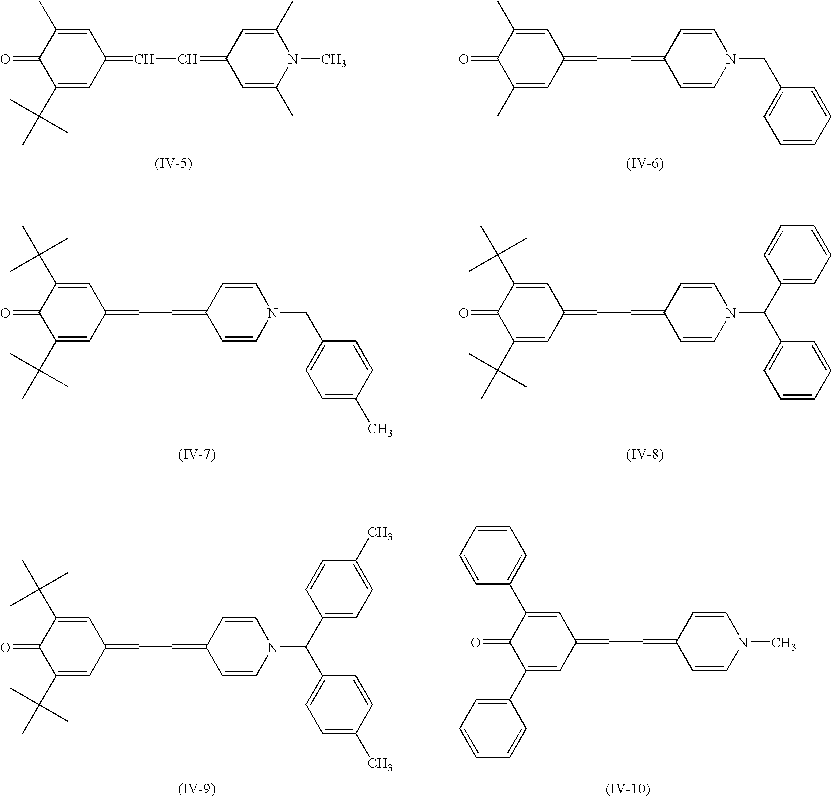

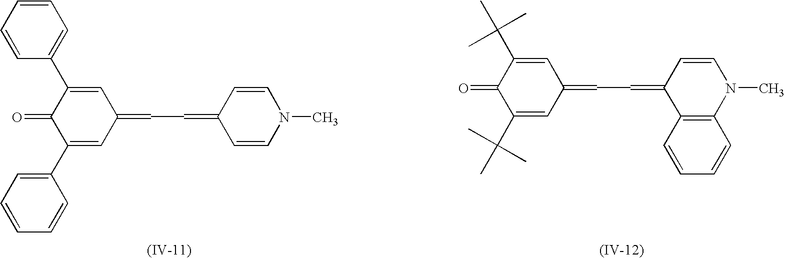

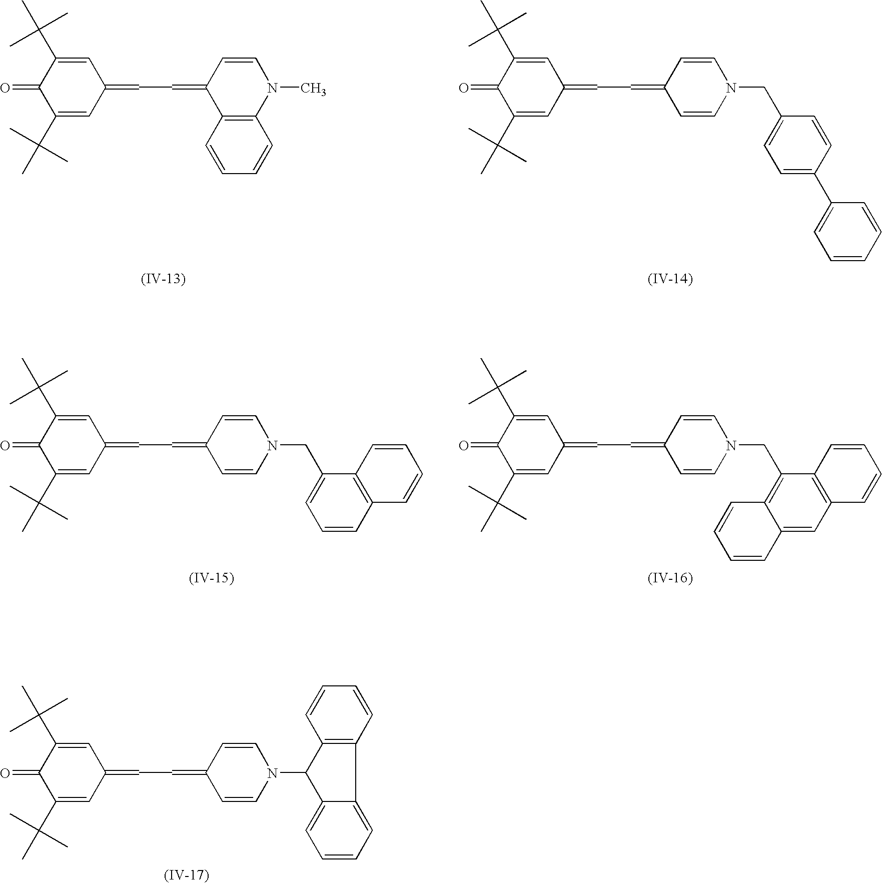

The phthalocyanine compounds include copper phthalocyanine, lead phthalocyanine, zinc phthalocyanine, aluminum phthalocyanine, iron phthalocyanine, cobalt phthalocyanine, tin phthalocyanine, titanyl phthalocyanine, and metal-free phthalocyanine.

Table 1 shows the work functions, ionization potentials, and electron affinities of examples of the metal microparticles, etc. and the organic insulating material.

As shown in Table 1, each of aluminum, gold, and copper has a work function at an energy level between the ionization potential and the electron affinity of 2-amino-4,5-imidazole dicyanate, whereby the dielectric constant can be effectively improved by accumulating charges in the metal microparticles. Further, by using the metal microparticles, which have such a particle diameter that the IP and EP calculated from the equations (I) and (II) with the work function WF shown in Table 1 are between the ionization potential and electron affinity of the organic insulating material, the dielectric constant can be effectively improved by accumulating charges in the metal microparticles. Furthermore, as shown in Table 1, each of the pyridone compounds, the phthalocyanine compounds, and α-6T has an ionization potential and an electron affinity at energy levels between those of 2-amino-4,5-imidazole dicyanate, whereby the dielectric constant can be effectively improved by accumulating charges in the organic charge trapping material.

TABLE 1

| | | Ionization | Electron | Work |
|---|---|---|---|---|
| | | potential | affinity | function |
| | | (eV) | (eV) | (eV) |
| Organic | 2-Amino-4,5-imidazole dicyanate | 5.60 *1 | 1.82 *1 | |
| insulating | Quinomethane compound A (see Example 5) | 6.03 *1 | 4.08 *1 | |
| material | Quinomethane compound B (see Example 6) | 6.01 *1 | 4.06 *1 | |
| | Triphenylamine compound C (see Example 7) | 5.41 *1 | 2.97 *1 | |
| | Triphenylamine compound D (see Example 8) | 5.22 *1 | 2.81 *1 | |
| | Pyridone compound E (see Example 9) | 4.93 *1 | 3.06 *1 | |
| | Triphenylamine compound G (see Example 15) | 5.5 *1 | 2.6 *1 | |
| | α-NPD | 5.5 | 2.4 | |
| | TPD | 5.5 | 2.4 | |
| | Alq3 | 5.8 | 3.1 | |
| | CBP | 6.0 | 2.9 | |
| Metal | Aluminum | 5.986 *2 | 0.441 *3 | 4.24 *4 |
| microparticles | Gold | 9.225 *2 | 0.441 *3 | 5.1 *4 |
| | Copper | 7.726 *2 | 1.228 *3 | 4.65 *4 |
| | Potassium | 4.341 *2 | 0.501 *3 | 2.8 *4 |
| | Sodium | 5.139 *2 | 0.548 *3 | 2.36 *4 |
| | Calcium | 6.113 *2 | <0 *3 | 2.9 *4 |
| | Magnesium | 7.646 *2 | <0 *3 | 3.66 *4 |
| | Indium | 5.786 *2 | 0.3 *3 | 4.09 *4 |
| | Platinum | 8.61 *2 | 2.128 *3 | 5.64 *4 |
| | Silver | 7.576 *2 | 1.302 *3 | 4.26 *4 |
| Organic charge | Pyridone compound E (see Example 12) | 4.93 *1 | 3.06 *1 | |
| trapping material | α-6T | 5.1 | 3.5 | |
| | Zinc phthalocyanine | 5.1 | 3.5 | |
| | Copper phthalocyanine | 5.1 | 3.5 | |

*1 Values measured in the invention
*2 Kagaku Binran, Kisohen II, 1993, page 618 to 619
*3 Kagaku Binran, Kisohen II, 1993, page 629
*4 Kagaku Binran, Kisohen II, 1993, page 489

The compounding volume ratio of the metal microparticles and the organic insulating material is preferably 1:1 to 8:1. When the amount of the metal microparticles is less than 1:1, the dielectric constant is too small and the desired properties are not obtained in some cases. When the amount of the metal microparticles is more than 8:1, the metal microparticles often come into contact with each other, so that the dispersion effect is not obtained and the particles are short-circuited.

The compounding volume ratio of the organic charge trapping material and the organic insulating material is preferably 1:100 to 1:1. When the amount of the organic charge trapping material is less than 1:100, the dielectric constant is too small and the desired properties are not obtained in some cases. When the amount of the organic charge trapping material is more than 1:1, the organic charge trapping materials often come into contact with each other, so that the dispersion effect is not obtained and the materials are short-circuited.

In the embodiment of dispersing the metal microparticles, etc. in the organic insulating material, it is preferred that the metal microparticles, etc. are uniformly dispersed. This is because in a nonuniform dispersion, the concentration of the metal microparticles, etc. is locally increased, and it is likely that the desired dispersion effect is not obtained due to contact of the metal microparticles, etc. with each other.

It is preferred that the electrode layer 21a, the dielectric material layer 30, and the electrode layer 21b are formed on the substrate 10 as thin films in this order.

The thin films of the electrode layers 21a and 21b preferably are formed by a known method such as vacuum deposition though the method of forming them is not particularly restricted.

The method for forming the dielectric material layer 30 is not particularly limited. It may be to mix, for example, the organic insulating material 31 and the metal microparticles, etc. 32 before applying them together. Alternatively, it may be to codeposit the organic insulating material 31 and the metal microparticles, etc. 32 Another exemplary alternative for forming the dielectric material layer 30 is to sandwich a layer of the metal microparticles, etc. 32 between layers of the organic insulating material 31, (in other words, form a layer of the metal microparticles, etc. 32 in the organic insulating material 31 as an intermediate layer). Also, the capacitor may have such a structure that the dielectric material layer 30 is further sandwiched between layers of the organic insulating material, in other words, the dielectric material layer 30 is formed as an intermediate layer in the organic insulating material.

In the method in which the organic insulating material and the metal microparticles, etc. are applied as a liquid mixture, it is preferred that methylene chloride, tetrahydrofuran, acetonitrile, ethyl alcohol or the like, is used as a solvent, and the metal microparticles, etc. and the organic insulating material are mixed at the above compounding volume ratio, diluted to a density of 0.3 to 3.0% by weight, and then applied. A surfactant, a resin binder, or the like may be added to the mixture if necessary. The application is preferably performed by a spin-coating method. The applied mixture is preferably dried at 70 to 110° C.

In the deposition step, the temperature of the substrate is appropriately selected according to the particular electrode material, organic insulating material and metal microparticles used. The temperature is preferably 0 to 150° C. in the formation of the electrode layers 21a and 21b, and is preferably 0 to 100° C. in the formation of the dielectric material layer 30.

In the method of depositing the mixture layer of the organic insulating material and the metal microparticles, etc., the vacuum is preferably 3×10⁻⁶ torr, the speed for forming the film of the organic insulating material is preferably 0.5 to 2.0 Angstroms/sec, and the speed for forming the film of the metal microparticles is preferably 0.1 to 1.0 Angstrom/sec. The film forming speeds within these ranges preferably are determined from the viewpoints of controlling the deterioration by the deposited material and controlling the crystal form of the deposited film.

The dielectric material layer 30 may be formed by spin coating, vacuum deposition, etc., which are common methods for forming organic thin films. In the case of particular metal microparticles of Au, Pt, Rh, Ag, for example, a diffusion method may be used such that after the organic insulating material film and the metal microparticle-film are stacked, they are heat-treated to diffuse the metal in the organic film.

The thickness of each electrode layer 21a, 21b is preferably 50 to 200 nm, and that of the dielectric material layer 30 is preferably 20 to 200 nm.

The mechanism of the high dielectric constant of the capacitor of the invention produced by the above method is not understood in detail, and seems to be as follows. That is, once a charge is injected to the metal microparticles, etc. by, for example, tunnel injection, the charge is trapped in the metal microparticles, etc. based on the energy level relative to the organic insulating material. The trapped charge acts in the same manner as dielectric polarization in the dielectric material, so that an extremely large dielectric constant can be exhibited in practical use even when the organic insulating material in it has a small dielectric constant.

Thus, even in the case of using the organic insulating material inherently having a smaller dielectric constant, the material as a practical matter can act as having a high dielectric constant, to provide the capacitor having a large capacity.

### EXAMPLES

The capacitor of the present invention will be described in further detail below with reference to Examples without intention of restricting the invention.

### Example 1

A capacitor having the structure shown in FIG. 1 was produced in the following manner.

A glass substrate was used as the substrate 10, and an aluminum thin film was formed as the electrode layer 21a by a vacuum deposition method. Then, in succession, 2-amino-4,5-imidazole dicyanate (available from Tokyo Kasei Kogyo Co., Ltd., Catalog Number A1292) as the organic insulating material 31 and aluminum as the metal microparticles 32 were codeposited to form the dielectric material layer 30, and a a thin film of aluminum was formed thereon as the electrode layer 21b, to produce a capacitor of Example 1.

The electrode layer 21a, the dielectric material layer 30, and the electrode layer 21b were formed such that the thicknesses thereof were 100 nm, 100 nm, and 100 nm, respectively. The average particle diameter of aluminum as the metal microparticles 32 was about 25 nm. The deposition was carried out by a diffusion pump exhaust deposition apparatus under a vacuum of 3×10⁻⁶ torr. Aluminum was deposited by a resistance heating method at a film forming speed of 3 Angstroms/sec. The 2-amino-4,5-imidazole dicyanate containing aluminum as the metal microparticles was formed by a code position method. The code position was achieved by a resistance heating method, the 2-amino-4,5-imidazole dicyanate film forming speed was 2 Angstroms/sec, and the aluminum film forming speed was 1 Angstrom/sec. The layers were deposited successively in one deposition apparatus such that the sample did not come into contact with air during the deposition processes.

### Example 2

2-Amino-4,5-imidazole dicyanate was used as the organic insulating material 31, gold was used as the metal microparticles 32, and they were codeposited to form a film as the dielectric material layer 30. A capacitor was produced under the same conditions as Example 1 except for the use of gold instead of aluminum.

### Example 3

2-Amino-4,5-imidazole dicyanate was used as the organic insulating material 31, copper was used as the metal microparticles 32, and they were codeposited to form a film as the dielectric material layer 30. A capacitor was produced under the same conditions as Example 1 except for the use of copper instead of aluminum.

### Example 4

2-Amino-4,5-imidazole dicyanate was used as the organic insulating material 31, and aluminum was used as the metal microparticles 32, to form the dielectric material layer 30. Further, layers containing only 2-amino-4,5-imidazole dicyanate were disposed between the dielectric material layer 30 and each of the electrodes 21a and 21b to form such a structure that the dielectric material layer 30 was an intermediate layer in the organic insulating material. The 2-amino-4,5-imidazole dicyanate layer having a thickness of 40 nm, the dielectric material layer 30 having a thickness of 20 nm, and the 2-amino-4,5-imidazole dicyanate layer having a thickness of 40 nm were stacked in this order by a vacuum deposition method to form a three-layer film. A capacitor was produced under the same conditions as Example 1 except for the manner of forming the film for the dielectric material layer 30.

### Example 5

The following quinomethane compound A was used as the organic insulating material 31 and aluminum was used as the metal microparticles 32 in the dielectric material layer 30, and a quinomethane compound layer having a thickness of 40 nm, the dielectric material layer having a thickness of 20 nm, and a quinomethane compound layer having a thickness of 40 nm were stacked in this order by a vacuum deposition method to form a three-layer film. A capacitor was produced under the same conditions as Example 1 except for the manner of forming the film for the dielectric material layer 30.

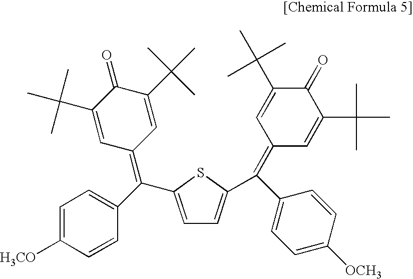

### Example 6

The following quinomethane compound B was used as the organic insulating material 31 and aluminum was used as the metal microparticles 32 in the dielectric material layer 30, and a quinomethane compound layer having a thickness of 40 nm, the dielectric material layer having a thickness of 20 nm, and a quinomethane compound layer having a thickness of 40 nm were stacked in this order by a vacuum deposition method to form a three-layer film. A capacitor was produced under the same conditions as Example 1 except for the manner of forming the film for the dielectric material layer 30.

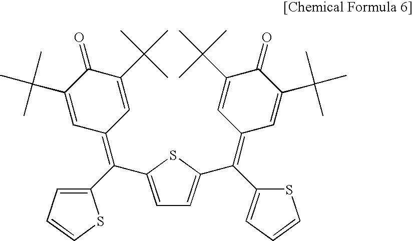

### Example 7

The following triphenylamine compound C was used as the organic insulating material 31 and aluminum was used as the metal microparticles 32 in the dielectric material layer 30, and a triphenylamine compound layer having a thickness of 40 nm, the dielectric material layer having a thickness of 20 nm, and a triphenylamine compound layer having a thickness of 40 nm were stacked in this order by a vacuum deposition method to form a three-layer film. A capacitor was produced under the same conditions as Example 1 except for the manner of forming the film for the dielectric material layer 30.

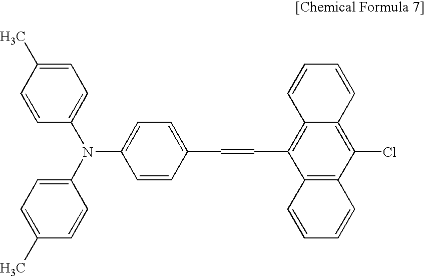

### Example 8

The following triphenylamine compound D was used as the organic insulating material 31 and aluminum was used as the metal microparticles 32 in the dielectric material layer 30, and a triphenylamine compound layer having a thickness of 40 nm, the dielectric material layer having a thickness of 20 nm, and a triphenylamine compound layer having a thickness of 40 nm were stacked in this order by a vacuum deposition method to form a three-layer film. A capacitor was produced under the same conditions as Example 1 except for the manner of forming the film for the dielectric material layer 30.

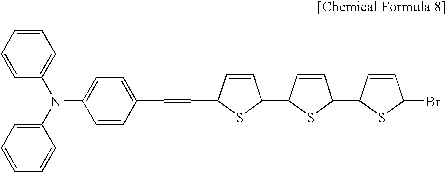

### Example 9

The following pyridone compound E was used as the organic insulating material 31 and aluminum was used as the metal microparticles 32 in the dielectric material layer 30, and a pyridone compound layer having a thickness of 40 nm, the dielectric material layer having a thickness of 20 nm, and a pyridone compound layer having a thickness of 40 nm were stacked in this order by a vacuum deposition method to form a three-layer film. A capacitor was produced under the same conditions as Example 1 except for the manner of farming the film for the dielectric material layer 30.

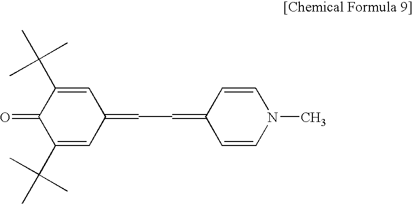

### Example 10

Copper phthalocyanine was used as the organic charge trapping material 32 instead of the metal microparticles 32, the 2-amino-4,5-imidazole dicyanate film forming speed was 1 Angstrom/sec, and the copper phthalocyanine film forming speed was 0.5 Angstrom/sec. A capacitor was produced under the same conditions as Example 1.

### Example 11

2-Amino-4,5-imidazole dicyanate was used as the organic insulating material 31, and copper phthalocyanine was used as the organic charge trapping material 32, to form the dielectric material layer 30. Further, layers containing only 2-amino-4,5-imidazole dicyanate were disposed between the dielectric material layer 30 and each of the electrodes 21a and 21b to form such a structure that the dielectric material layer 30 was an intermediate layer in the organic insulating material. The 2-amino-4,5-imidazole dicyanate layer having a thickness of 30 nm, the dielectric material layer 30 having a thickness of 40 nm, and the 2-amino-4,5-imidazole dicyanate layer having a thickness of 30 nm were stacked in this order by a vacuum deposition method to form a three-layer film. A capacitor was produced under the same conditions as Example 10 except for the manner of forming the film for the dielectric material layer 30.

### Example 12

2-Amino-4,5-imidazole dicyanate was used as the organic insulating material 31 and the above pyridone compound E was used as the organic charge trapping material 32 in the dielectric material layer 30, and a 2-amino-4,5-imidazole dicyanate layer having a thickness of 30 nm, the dielectric material layer 30 having a thickness of 40 nm, and a 2-amino-4,5-imidazole dicyanate layer having a thickness of 30 nm were stacked in this order by a vacuum deposition method to form a three-layer film. A capacitor was produced under the same conditions as Example 11.

### Example 13

2-Amino-4,5-imidazole dicyanate was used as the organic insulating material 31 and α-6T was used as the organic charge trapping material 32 in the dielectric material layer 30, and a 2-amino-4,5-imidazole dicyanate layer having a thickness of 30 nm, the dielectric material layer 30 having a thickness of 40 nm, and a 2-amino-4,5-imidazole dicyanate layer having a thickness of 30 nm were stacked in this order by a vacuum deposition method to form a three-layer film. A capacitor was produced under the same conditions as Example 11.

### Example 14

The following triphenylamine compound F was used as the organic insulating material 31 and copper phthalocyanine was used as the organic charge trapping material 32 in the dielectric material layer 30, and a triphenylamine compound layer having a thickness of 40 nm, the dielectric material layer having a thickness of 20 nm, and a triphenylamine compound layer having a thickness of 40 nm were stacked in this order by a vacuum deposition method to form a three-layer film. A capacitor was produced under the same conditions as Example 11.

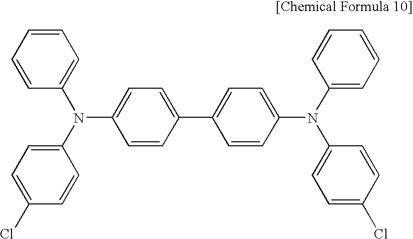

### Example 15

The following triphenylamine compound G was used as the organic insulating material 31 and copper phthalocyanine was used as the organic charge trapping material 32 in the dielectric material layer 30, and a triphenylamine compound layer having a thickness of 40 nm, the dielectric material layer having a thickness of 20 nm, and a triphenylamine compound layer having a thickness of 40 nm were stacked in this order by a vacuum deposition method to form a three-layer film. A capacitor was produced under the same conditions as Example 11.

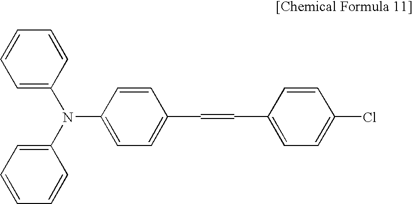

### Example 16

α-NPD was used as the organic insulating material 31 and copper phthalocyanine was used as the organic charge trapping material 32 in the dielectric material layer 30, and an α-NPD layer having a thickness of 40 nm, the dielectric material layer having a thickness of 20 nm, and an α-NPD layer having a thickness of 40 nm were stacked in this order by a vacuum deposition method to form a three-layer film. A capacitor was produced under the same conditions as Example 11.

### Comparative Example 1

A glass substrate was used as the substrate 10, and by a vacuum deposition method, aluminum was formed into the electrode layer 21a, 2-amino-4,5-imidazole dicyanate was formed into the dielectric material layer, and aluminum was formed into a thin film for the electrode layer 21b, successively, to produce a capacitor of Comparative Example 1. The production conditions were equal to those of Example 1 except for not codepositing aluminum with 2-amino-4,5-imidazole dicyanate.

### Comparative Example 2

A capacitor of Comparative Example 2 was produced in the same manner as Comparative Example 1 except for using the quinomethane compound A of Example 5 in the dielectric material layer.

### Comparative Example 3

A capacitor of Comparative Example 3 was produced in the same manner as Comparative Example 1 except for using the quinomethane compound B of Example 6 in the dielectric material layer.

### Comparative Example 4

A capacitor of Comparative Example 4 was produced in the same manner as Comparative Example 1 except for using the triphenylamine compound C of Example 7 in the dielectric material layer.

### Comparative Example 5

A capacitor of Comparative Example 5 was produced in the same manner as Comparative Example 1 except for using the triphenylamine compound D of Example 8 in the dielectric material layer.

### Comparative Example 6

A capacitor of Comparative Example 6 was produced in the same manner as Comparative Example 1 except for using the pyridone compound E of Example 9 in the dielectric material layer.

### Comparative Example 7

A glass substrate was used as the substrate 10, and by a vacuum deposition method, aluminum was formed into the electrode layer 21a, 2-amino-4,5-imidazole dicyanate was formed into the dielectric material layer, and aluminum was formed into a thin film for the electrode layer 21b, successively, to produce a capacitor of Comparative Example 7. The production conditions were equal to those of Example 10 except for not codepositing copper phthalocyanine with 2-amino-4,5-imidazole dicyanate.

### Comparative Example 8

A capacitor of Comparative Example 8 was produced in the same manner as Comparative Example 7 except for using the triphenylamine compound F of Example 14 in the dielectric material layer.

### Comparative Example 9

A capacitor of Comparative Example 9 was produced in the same manner as Comparative Example 7 except for using the triphenylamine compound G of Example 15 in the dielectric material layer.

### Comparative Example 10

A capacitor of Comparative Example 10 was produced in the same manner as Comparative Example 7 except for using α-NPD of Example 16 in the dielectric material layer.

[Evaluation Method]

The relative dielectric constants of the capacitors of Examples 1 to 16 and Comparative Examples 1 to 10 were measured at the room temperature. The relative dielectric constants were measured by an impedance analyzer YHP4192A manufactured by Yokogawa-Hewlett Packard, Ltd. The measured relative dielectric constants at 1 kHz are shown in Table 2. Further, a scanning electron microscope (SEM) photograph of the surface of the dielectric material layer of Example 1 is shown in FIG. 2.

TABLE 2

| | Structure of dielectric material layer | | | Evaluation |
|---|---|---|---|---|
| | | Metal microparticles or | | Relative |
| | | organic charge | | dielectric |
| | Functional organic material | trapping material | Film | constant |
| Example 1 | 2-Amino-4,5-imidazole dicyanate | Aluminum | Codeposited film | 156 |
| Example 2 | 2-Amino-4,5-imidazole dicyanate | Gold | Codeposited film | 244 |
| Example 3 | 2-Amino-4,5-imidazole dicyanate | Copper | Codeposited film | 75 |
| Example 4 | 2-Amino-4,5-imidazole dicyanate | Aluminum | Three-layered film | 96 |
| Example 5 | Quinomethane compound | Aluminum | Three-layered film | 11.5 |
| Example 6 | Quinomethane compound | Aluminum | Three-layered film | 37.3 |
| Example 7 | Triphenylamine compound | Aluminum | Three-layered film | 17.3 |
| Example 8 | Triphenylamine compound | Aluminum | Three-layered film | 21.8 |
| Example 9 | Pyridone compound | Aluminum | Three-layered film | 32 |
| Example 10 | 2-Amino-4,5-imidazole dicyanate | Copper phthalocyanine | Codeposited film | 57 |
| Example 11 | 2-Amino-4,5-imidazole dicyanate | Copper phthalocyanine | Three-layered film | 42 |
| Example 12 | 2-Amino-4,5-imidazole dicyanate | Pyridone compound | Three-layered film | 29 |
| Example 13 | 2-Amino-4,5-imidazole dicyanate | α-6T | Three-layered film | 35 |
| Example 14 | Triphenylamine compound | Copper phthalocyanine | Three-layered film | 17 |
| Example 15 | Triphenylamine compound | Copper phthalocyanine | Three-layered film | 26 |
| Example 16 | α-NPD | Copper phthalocyanine | Three-layered film | 65 |
| Comp. Ex. 1 | 2-Amino-4,5-imidazole dicyanate | None | Deposited film | 3.6 |
| Comp. Ex. 2 | Quinomethane compound | None | Deposited film | 2.1 |
| Comp. Ex. 3 | Quinomethane compound | None | Deposited film | 2.5 |
| Comp. Ex. 4 | Triphenylamine compound | None | Deposited film | 2.7 |
| Comp. Ex. 5 | Triphenylamine compound | None | Deposited film | 3.2 |
| Comp. Ex. 6 | Pyridone compound | None | Deposited film | 3.0 |
| Comp. Ex. 7 | 2-Amino-4,5-imidazole dicyanate | None | Deposited film | 3 |
| Comp. Ex. 8 | Triphenylamine compound | None | Deposited film | 3 |
| Comp. Ex. 9 | Triphenylamine compound | None | Deposited film | 4 |
| Comp. Ex. 10 | α-NPD | None | Deposited film | 3 |

As shown in Table 2, while the relative dielectric constant of 2-amino-4,5-imidazole dicyanate used as the organic insulating material 31 was measured in Comparative Example 1, the relative dielectric constants of Examples 1 to 4 were 20 to 70 times as large as that of Comparative Example 1 despite the use of the same organic insulating material. Further, the quinomethane organic materials, triphenylamine compounds, and the pyridone compound were used as the organic insulating material 31 in Examples 5 to 9 to exhibit the large dielectric constants, which were 5 to 20 times as large as those of Comparative Examples 2 to 6.

Similarly, as shown in Table 2, while the relative dielectric constant of 2-amino-4,5-imidazole dicyanate used as the organic insulating material 31 was measured in Comparative Example 7, the relative dielectric constants of Examples 10 to 13 were 10 to 20 times as large as that of Comparative Example 7 despite the use of the same organic insulating material. Further, the triphenylamine compounds and α-NPD were used as, the organic insulating material 31 in Examples 14 to 16 to show the large dielectric constants, which were 5 to 20 times as large as those of Comparative Examples 8 and 9.

### INDUSTRIAL APPLICABILITY

According to the present invention, there is provided the capacitor capable of showing a large relative dielectric constant and large capacity even in the case of using an organic insulating material with a low relative dielectric constant. Further, the capacitor is flexible and can be produced at low temperature near room temperature, and thereby can be suitably used in various places such as printed circuit boards and integrated circuits.

1. A dielectric material, comprising
an organic insulating material, and
at least one of metal microparticles and an organic charge trapping material, in the organic insulating material,
wherein the metal microparticles have a work function at an energy level between the ionization potential and the electron affinity of the organic insulating material.

2. The dielectric material according to claim 1, wherein the at least one of metal microparticles and the organic charge trapping material is dispersed in the organic insulating material.

3. The dielectric material according to claim 1, wherein the organic insulating material is selected from the group consisting of 2-amino-4,5-imidazole dicyanate, quinomethane compounds, triphenylamine compounds, pyridone compounds, polystyrenes, polyvinyl carbazoles, α-NPD, TPD, Alq3, and CBP.

4. The dielectric material according to claim 1, wherein the organic insulating material is selected from the group consisting of 2-amino-4,5-imidazole dicyanate, triphenylamine compounds, and α-NPD, and the organic charge trapping material is selected from the group consisting of pyridone compounds, phthalocyanine compounds, and α-6T.

5. A capacitor comprising a layer of the dielectric material according to claim 1 and two electrodes sandwiching the layer.

6. A capacitor comprising the dielectric material according to claim 1, layers of an organic insulating material sandwiching the dielectric material, and electrodes sandwiching the layers.

7. A method for producing a capacitor, comprising the steps of
forming a first electrode thin film,
applying to the first electrode thin film a liquid mixture containing an organic insulating material, and at least one of metal microparticles and an organic charge trapping material,
after said applying step, drying the mixture to form a dried film coating the first electode thin film, and
forming a second electrode thin film on the dried film.

8. A method for producing a capacitor, comprising the steps of
forming a first electrode thin film,
codepositing an organic insulating material, and at least one of metal microparticles and an organic charge trapping material, on the formed first electrode thin film, and
forming a second electrode thin film on the codeposited film.

9. A dielectric material according to claim 1, wherein a layer of the at least one of metal microparticles and/or organic charge trapping material is sandwiched between layers of the organic insulating material.

10. A dielectric material, comprising
an organic insulating material, and
at least one of metal microparticles and an organic charge trapping material, in the organic insulating material,
wherein the at least one of metal microparticles or organic charge trapping material has an ionization potential and an electron affinity at an energy level between the ionization potential and the electron affinity of the organic insulating material.

11. A dielectric material according to claim 10, wherein a layer of the at least one of metal microparticles and/or organic charge trapping material is sandwiched between layers of the organic insulating material.

12. The dielectric material according to claim 10, wherein the at least one of metal microparticles and organic charge trapping material is dispersed in the organic insulating material.

13. The dielectric material according to claim 10, wherein the organic insulating material is selected from the group consisting of 2-amino-4,5-imidazole dicyanate, quinomethane compounds, triphenylamine compounds, pyridone compounds, polystyrenes, polyvinyl carbazoles, α-NPD, TPD, Alq3, and CBP.

14. The dielectric material according to claim 10, wherein the organic insulating material is selected from the group consisting of 2-amino-4,5-imidazole dicyanate, triphenylamine compounds, and α-NPD, and the organic charge trapping material is selected from the group consisting of pyridone compounds, phthalocyanine compounds, and α-6T.

15. A capacitor comprising a layer of the dielectric material according to claim 10 and two electrodes sandwiching the layer.

16. A capacitor comprising the dielectric material according to claim 10, layers of an organic insulating material sandwiching the dielectric material, and electrodes sandwiching the layers.
